(19) United States
(12) Patent Application Publication
(10) Pub. No.: US 2025/0335195 A1
(43) Pub. Date: Oct. 30, 2025

(54) AUTOMATED SOFTWARE DEVELOPMENT FOR REAL-TIME DEPENDENCY HEALTH MANAGEMENT

(71) Applicant: INTERNATIONAL BUSINESS MACHINES CORPORATION, Armonk, NY (US)

(72) Inventors: Vlad Balanescu, Southampton (GB); Matthew Paul Chapman, Eastleigh (GB); Lucinda Cole, Portsmouth (GB); Andreas Evripidou, Sheffield (GB)

(21) Appl. No.: 18/651,041

(22) Filed: Apr. 30, 2024

(51) Int. Cl. G06F 8/77; G06F 21/57

(52) U.S. Cl. CPC G06F 8/77; G06F 21/577; G06F 2221/033

(57) ABSTRACT

Systems and methods are provided for proactive dependency management in software development projects, including initiating a dependency scan within a version-controlled repository to identify and list project dependencies at predetermined intervals, and conducting a health analysis for the project dependencies listed by accessing and utilizing data from a plurality of vulnerabilities databases, the analysis uncovering current security vulnerabilities and assessing a frequency and recency of maintenance updates. A multifaceted criteria matrix is applied to analyzed dependencies to isolate those that exhibit indicators of potential risk, including known security vulnerabilities and evidence of neglect of updates and maintenance. A set of alternative dependencies is aggregated for identified at-risk dependencies by leveraging public repository analysis to discern commonly adopted replacements, further evaluating the alternative dependencies for compatibility with a technology stack of the software development projects and adherence to security and maintenance standards.

### BACKGROUND

The present invention generally relates to software development and maintenance, and more particularly to an automated system and method for real-time health management of software dependencies within a development project's lifecycle.

In the realm of software development, dependency management has conventionally been approached through manual monitoring and updates, utilizing tools that scan and alert developers to known security vulnerabilities in software libraries. These conventional systems operate in isolation, reacting to known issues without considering the broader context of the project's architecture or the unique demands of its technology stack. For example, identifying a vulnerable dependency with conventional systems and methods does not lead to a determination of actionable insights on suitable replacements or adjustments necessary for the specific environment. This reactive approach lacks a holistic view that encompasses the health and sustainability of the entire dependency tree over the lifecycle of a project. Additionally, the conventional systems and methods do not seamlessly integrate with the continuous workflows inherent in modern software development (e.g., CI/CD pipelines), nor does it proactively leverage the collective intelligence of the developer community or Artificial Intelligence systems.

### SUMMARY

In accordance with an embodiment of the present invention, a method is provided for proactive dependency management in software development projects, including initiating a dependency scan within a version-controlled repository to identify and list project dependencies at predetermined intervals, and conducting a health analysis for the project dependencies listed by accessing and utilizing data from a plurality of vulnerabilities databases, the analysis uncovering current security vulnerabilities and assessing a frequency and recency of maintenance updates. A multifaceted criteria matrix is applied to analyzed dependencies to isolate those that exhibit indicators of potential risk, including known security vulnerabilities and evidence of neglect of updates and maintenance. A set of alternative dependencies is aggregated for identified at-risk dependencies by leveraging public repository analysis to discern commonly adopted replacements, further evaluating the alternative dependencies for compatibility with a technology stack of the software development projects and adherence to security and maintenance standards.

According to another aspect of the present invention, a system is provided for proactive dependency management in software development projects, including a processor device and a memory storing instructions that when executed by the processor device, cause the system to initiate a dependency scan within a version-controlled repository to identify and list project dependencies at predetermined intervals, and conduct a health analysis for the project dependencies listed by accessing and utilizing data from a plurality of vulnerabilities databases, the analysis uncovering current security vulnerabilities and assessing a frequency and recency of maintenance updates. A multifaceted criteria matrix is applied to analyzed dependencies to isolate those that exhibit indicators of potential risk, including known security vulnerabilities and evidence of neglect of updates and maintenance. A set of alternative dependencies is aggregated for identified at-risk dependencies by leveraging public repository analysis to discern commonly adopted replacements, further evaluating the alternative dependencies for compatibility with a technology stack of the software development projects and adherence to security and maintenance standards.

According to another aspect of the present invention, a computer program product is provided for proactive dependency management in software development projects, including instructions to initiate a dependency scan within a version-controlled repository to identify and list project dependencies at predetermined intervals, and conduct a health analysis for the project dependencies listed by accessing and utilizing data from a plurality of vulnerabilities databases, the analysis uncovering current security vulnerabilities and assessing a frequency and recency of maintenance updates. A multifaceted criteria matrix is applied to analyzed dependencies to isolate those that exhibit indicators of potential risk, including known security vulnerabilities and evidence of neglect of updates and maintenance. A set of alternative dependencies is aggregated for identified at-risk dependencies by leveraging public repository analysis to discern commonly adopted replacements, further evaluating the alternative dependencies for compatibility with a technology stack of the software development projects and adherence to security and maintenance standards.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a method for initializing and performing dependency health analysis and management in a software development project environment, in accordance with embodiments of the present invention;

FIG. 3 is a diagram illustratively depicting a method for automated scanning and analysis of dependencies in a software development project environment, in accordance with embodiments of the present invention;

FIG. 4 is a diagram illustratively depicting a method for managing health of software dependencies, including processes for initiating a dependency check, identifying and evaluating the health of dependencies, and updating dependency lists with healthier alternatives, in accordance with embodiments of the present invention;

FIG. 5 is a diagram illustratively depicting a method for scraping developer platforms to identify new replacement dependencies for a software project, including searching and filtering pull requests to create a popularity map of potential alternatives, in accordance with embodiments of the present invention;

FIG. 6 is a diagram illustratively depicting a method for proactive dependency management system integrated within a CI/CD pipeline, including a dependency scan initiation and automated implementation of selected dependency alternatives in a production environment, in accordance with embodiments of the present invention;

FIG. 7 is a diagram illustratively depicting a high-level view of a system for real-time dependency health management by dependency identification, health analysis, risk assessment, and application of neural network algorithms for predictive analysis and decision-making support in software development projects, in accordance with embodiments of the present invention; and

FIG. 8 is a diagram illustratively depicting an exemplary processing system for improved, real-time software dependency health management by dependency identification, health analysis, risk assessment, and application of neural network algorithms for predictive analysis and decision-making support in software development projects, in accordance with embodiments of the present invention.

### DETAILED DESCRIPTION

The present invention pertains to the field of software development, in particular focusing on the proactive management of software dependencies. In today's complex development ecosystems, where applications are built on a multitude of open-source and proprietary components, ensuring the health and security of dependencies is paramount. The present invention introduces a comprehensive system and method for monitoring, analyzing, and managing these dependencies, particularly addressing the challenges associated with maintaining their security and stability throughout the software development lifecycle.

At the core of the invention is a dependency health management process, which can be initiated on a set schedule to align with various stages of the software development process, such as the initiation of new builds within a continuous integration/continuous deployment (CI/CD) pipeline. This process leverages sophisticated algorithms to scan version-controlled repositories to create an exhaustive list of project dependencies. Each dependency can then be evaluated against known vulnerabilities, update frequencies, and maintenance activities by accessing a plurality of vulnerabilities databases. Dependencies that fail to meet the predetermined health criteria can be identified as problematic and flagged for further action.

In various embodiments, the present invention can identify problematic dependencies, and also can suggest and/or automatically implement viable alternatives. Utilizing data from developer platforms, such as GitHub, the system can mine for community-driven replacements that have been adopted in similar project contexts. This approach ensures that proposed alternatives are not only secure but also carry community trust, enhancing the likelihood of their adoption. The suggested replacements can be evaluated for compatibility with the project's technology stack and compliance with security and maintenance standards before being ranked based on their health and popularity.

Some embodiments of the invention integrate this process within a CI/CD pipeline, allowing for real-time, automated dependency scanning and updates. The invention is a flexible solution, capable of adapting to various programming languages and dependency management systems, making it universally applicable across diverse development environments. Further embodiments enhance the system's capabilities with an artificial intelligence model that can predict emerging vulnerabilities, providing an anticipatory layer of security against potential threats.

In various embodiments, the present invention provides an automated, data-driven approach to dependency management, enabling software projects to maintain a secure, stable, and up-to-date dependency tree. By automating various aspects of dependency analysis and employing advanced predictive analytics, the system represents a significant advancement in the tools available to developers for maintaining the health of their software projects, in accordance with aspects of the present invention.

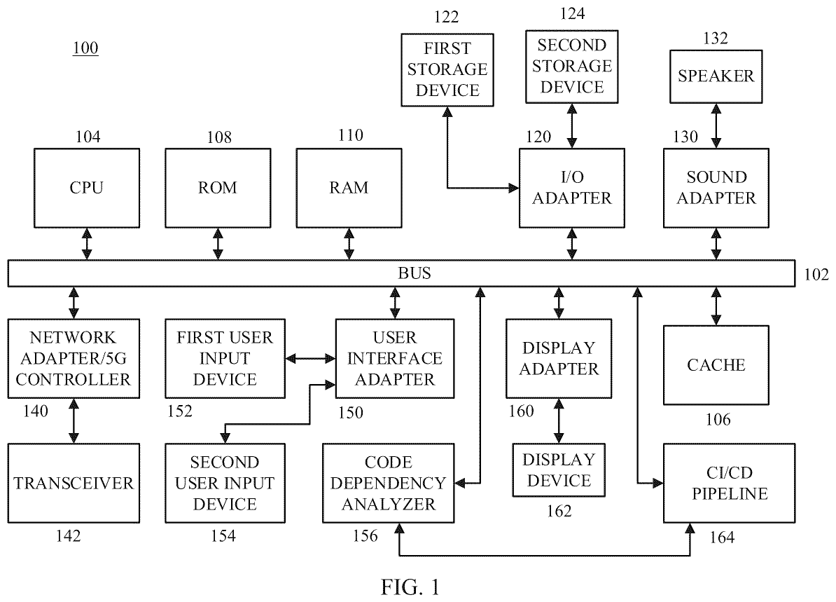

Referring now to the drawings in which like numerals represent the same or similar elements and initially to FIG. 1, an exemplary processing system 100, to which the present principles may be applied, is illustratively depicted in accordance with embodiments of the present invention.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. A Vision Language (VL) model can be utilized in conjunction with a semantic search engine 164 for text and/or image processing tasks, and can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. The VL model 156 can be included in a system with one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. A VL model 156 can process received input, and a semantic search engine 164 can be operatively connected to the system 100 for semantic searching and image retrieval tasks, in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

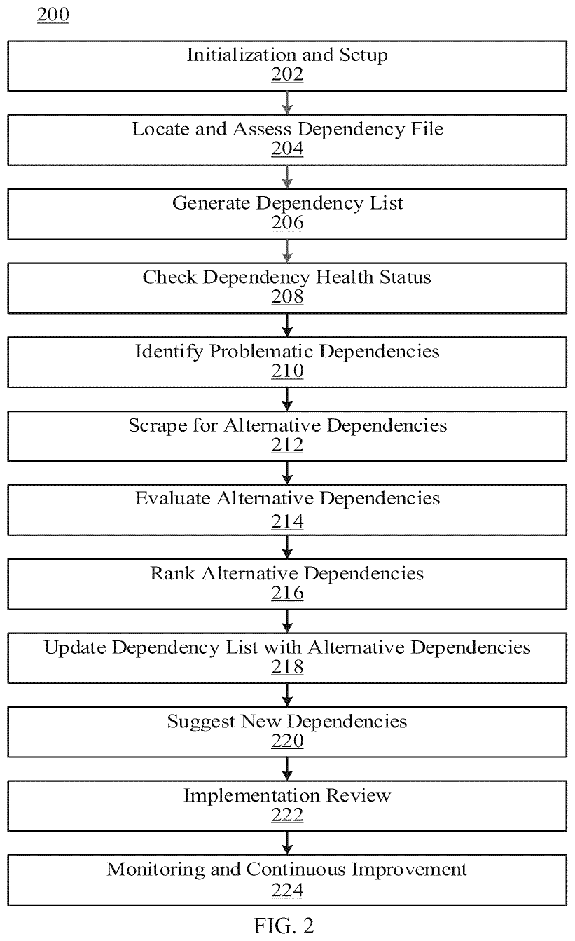

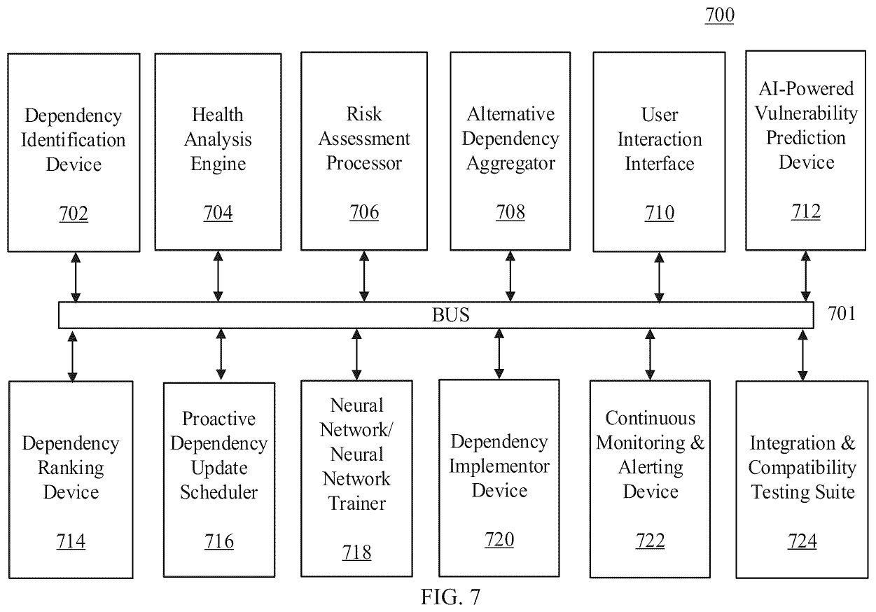

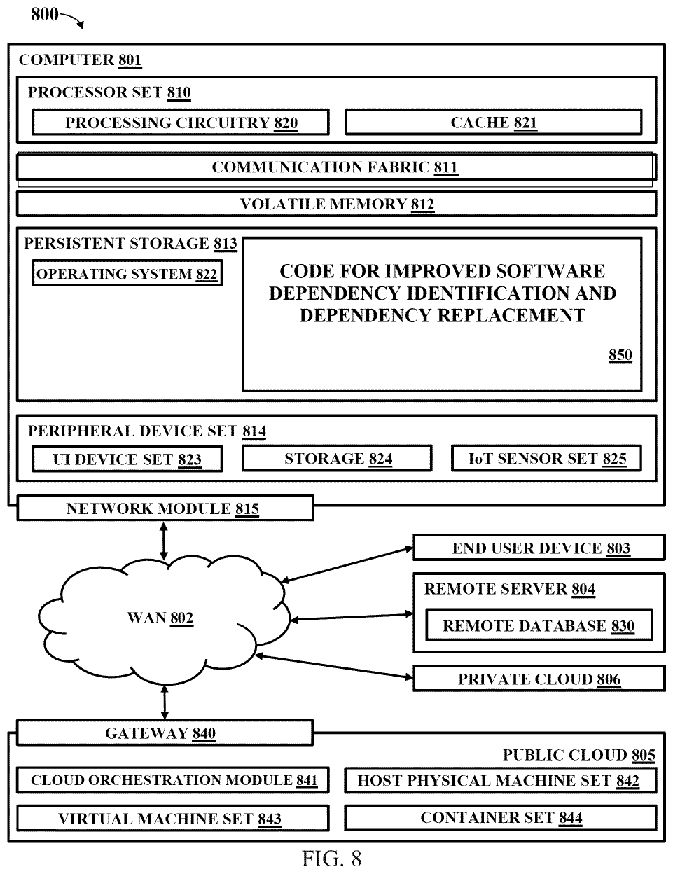

Moreover, it is to be appreciated that systems 700 and 800, described below with respect to FIGS. 7 and 8, respectively, are systems for implementing respective embodiments of the present invention. Part or all of processing system 100 may be implemented in one or more of the elements of systems 700 and 800, in accordance with aspects of the present invention. Further, it is to be appreciated that processing system 100 may perform at least part of the methods described herein including, for example, at least part of methods 200, 300, 400, 500, and 600, described below with respect to FIGS. 2, 3, 4, 5, and 6, respectively. Similarly, part or all of systems 700 and 800 may be used to perform at least part of methods 200, 300, 400, 500, and 600 of FIGS. 2, 3, 4, 5, and 6, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result. In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a method 200 for initializing and performing dependency health analysis and management in a software development project environment, is illustratively depicted in accordance with embodiments of the present invention.

In various embodiments, in block 202, the process can be initiated when the system activates on a pre-set schedule, which can be integrated within, for example, a continuous integration/continuous deployment (CI/CD) pipeline, such as a nightly build process. This block involves the system waking from a dormant state, verifying its operational parameters, and confirming access to the target repository. The system can then preload its operational context with configurations, such as target repositories, dependency file locations (e.g., package.json for Node.js projects), and thresholds for dependency health criteria. This setup phase ensures that the tool is primed to execute its analysis with the current operational parameters and access rights, aligning with the security and access protocols of the repository hosting services.

In block 204, the tool can identify and access the dependency file within the codebase. This step can include parsing the repository structure to locate the file that enumerates the project's dependencies, such as package.json in Node.js projects. The tool can then read the contents of this file, extracting the list of dependencies along with their respective versions. This action allows the system to compile a comprehensive list of current dependencies for subsequent analysis, which can ensure that all dependencies are accounted for in the health assessment process. In block 206, a detailed list of all dependencies identified in the previous step can be created or updated. This list serves as the foundational element for the tool's subsequent analysis, encompassing all the dependencies with their specific versions and other pertinent metadata. The system can employ algorithms to ensure that the list is exhaustive and reflects the latest state of the repository's dependency tree, facilitating an accurate assessment of each dependency's health and risk profile.

In block 208, the health status of each dependency can be evaluated by checking against known vulnerability databases and other sources of security and maintenance information (e.g., snyk.com). This process can include assessing the frequency of updates, the presence of active maintenance, and any known security vulnerabilities associated with each package. This evaluation can be automated, leveraging public APIs and proprietary databases to fetch the most current information, ensuring that the assessment reflects real-time data on the dependencies' health. In block 210, dependencies that do not meet predetermined health criteria or benchmarks can be flagged as problematic. This can include packages with known security vulnerabilities, those lacking recent updates, or those not actively maintained. The criteria used to define a “problematic” dependency can be configurable by users, allowing for flexibility in how risk is assessed based on the specific requirements of the project or security policies in place.

In block 212, for each problematic dependency identified, the tool can scrape developer platforms (e.g., GitHub repositories using GitHub's public API) to find instances where the dependency has been replaced with an alternative in other projects. This scraping can utilize advanced data mining techniques to analyze pull requests and commits for patterns of substitution, identifying viable alternatives that have been adopted by the community in similar contexts. In block 214, alternative dependencies discovered in the previous step can be evaluated based on their health and popularity within the community. This evaluation can include analyzing security posture, frequency of updates, level of community support, and overall stability. A goal of this step is to ensure that any proposed alternatives are not only free from the issues identified with the original dependencies but also are sustainable choices for integration into the project. In block 216, the identified alternative dependencies can be ranked based on a composite score reflecting their health, popularity, and relevance to the project's requirements. This ranking facilitates the prioritization of alternatives, guiding developers towards the most suitable replacements that balance security, maintenance, and community endorsement.

In block 218, the list of dependencies can be updated to include information on the problematic packages and the ranked list of alternatives. This updated list can serve as a recommendation guide and/or automated dependency update guide, providing developers with actionable insights on which dependencies are advisable to replace and with what alternatives, based on comprehensive analysis and evaluation. In block 220, new dependencies can be suggested to the users (e.g., developers), aiming to replace the identified problematic ones with higher-quality alternatives. These suggestions can be derived from the preceding analysis and ranking steps, offering a data-driven approach to improving the project's dependency health and security posture.

In block 222, developers can act as a “human-in-the-loop” to evaluate the suggestions made in block 220 by the tool. They can then decide on implementing the proposed changes, considering the impact on the project's functionality and the overall benefits of the new dependencies, and can also set the system to automatically apply dependency updates without a human-in-the-loop in some embodiments. This step emphasizes the collaborative aspect of dependency management, where automated tools and human judgment can converge to optimize project outcomes. In block 224, the tool can re-enter a monitoring phase post-implementation, continuously analyzing the repository's dependencies against new vulnerabilities and maintenance updates. This ensures that the project remains secure and up-to-date, adapting to emerging threats and evolving community standards. This ongoing process reinforces the tool's value in maintaining the health and security of the project's dependencies over time, in accordance with aspects of the present invention.

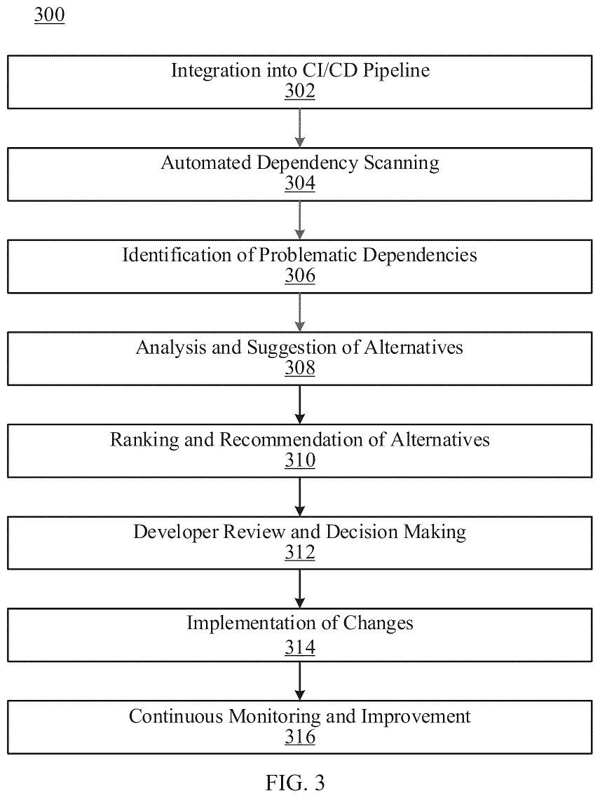

Referring now to FIG. 3, a method 300 for automated scanning and analysis of dependencies in a software development project environment, is illustratively depicted in accordance with embodiments of the present invention.

In various embodiments, in block 302, a dependency analysis and alternative proposal tool can be integrated into the continuous integration and continuous deployment (CI/CD) pipeline of a software development project. This integration involves configuring the tool to automatically run as part of the CI/CD process, ensuring that dependency checks are performed at each build or deployment phase. This step can be utilized for embedding the tool within the SDLC, enabling real-time monitoring and management of dependencies. In block 304, upon initiation of a new build or deployment within the CI/CD pipeline, the tool automatically performs a comprehensive scan of the project's dependency tree. This includes identifying all open-source packages the project depends on, along with their versions and health status. This automated scanning is designed to detect any known security vulnerabilities, outdated packages, or dependencies flagged for lack of maintenance.

In block 306, the results from the automated dependency scan can be analyzed to identify problematic dependencies based on predefined criteria such as known vulnerabilities, outdatedness, and maintenance activity. This identification process employs sophisticated algorithms to assess each dependency's risk profile, ensuring that developers are alerted to potential issues that could compromise the project's security or reliability. In block 308, for each problematic dependency identified, an in-depth analysis to suggest viable alternatives can be executed. This can include mining data from public repositories (e.g., GitHub) and using, for example, GitHub's public API to learn and understand how similar projects have addressed the same dependency issues. The tool can evaluate the health, security, and popularity of potential alternatives, ensuring that the suggestions are both practical and beneficial for the project. In block 310, the identified alternatives for each problematic dependency can be ranked based on a set of metrics including, for example, security posture, maintenance history, and community adoption. It then can generate and/or automatically apply recommendations, presenting developers with a list of alternative packages along with relevant data to aid in decision-making. This step facilitates informed choices about dependency replacements, optimizing the project's dependency tree for security and stability.

In block 312, developers can review the recommendations within the context of the CI/CD pipeline, functioning as a “human-in-the-loop”. This review process can include evaluating the suggested alternatives against the project's specific needs and constraints. Developers can make informed decisions on whether to accept, modify, or reject the proposed changes, ensuring that the tool's recommendations are implemented in a manner that best suits different, specific projects. In block 314, upon approval of the recommended dependency changes, an implementation process can be initiated. This can include automating the creation of pull requests for the replacement of problematic dependencies with chosen alternatives. The system can automatically (or upon user-approval) merge these changes into the codebase as part of the CI/CD process, ensuring that the project's dependencies are updated efficiently and securely. In block 316, the tool continues to monitor the project's dependencies as part of the CI/CD pipeline, providing ongoing analysis and suggestions for improvement. This continuous monitoring ensures that the project remains up-to-date with the latest security patches and dependency updates, fostering a proactive approach to dependency management. In practice in real world software development environments, the present invention can enhance project security and maintainability through automated dependency management throughout the software development life cycle (SDLC), in accordance with aspects of the present invention.

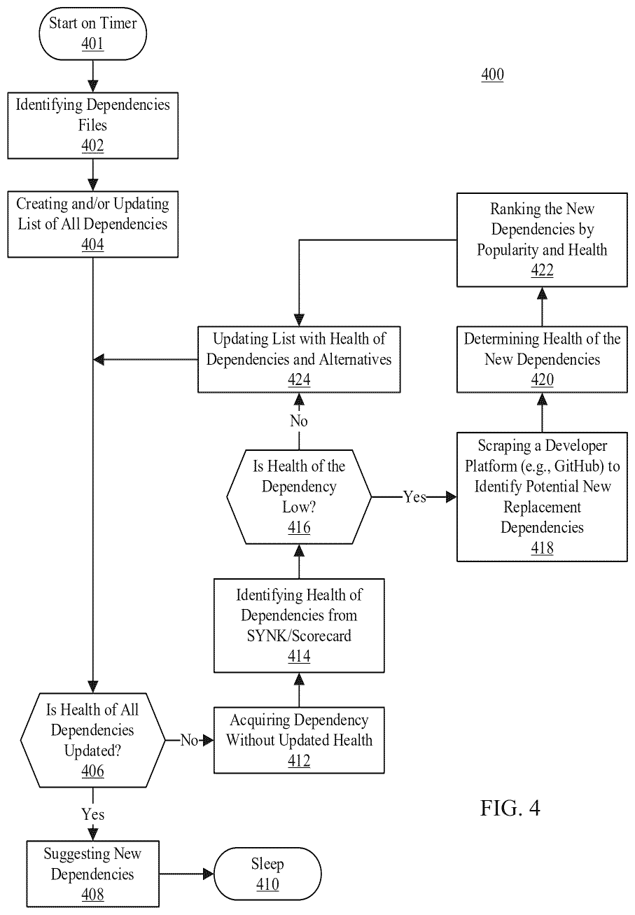

Referring now to FIG. 4, a method 400 for managing health of software dependencies, including processes for initiating a dependency check, identifying and evaluating the health of dependencies, and updating dependency lists with healthier alternatives, is illustratively depicted in accordance with embodiments of the present invention.

In various embodiments, in block 401, the dependency management process can be initiated by a timer mechanism. This scheduler can be carefully calibrated to coincide with the software development lifecycle, particularly integrated into a continuous integration/continuous deployment (CI/CD) pipeline, which might be configured to trigger at the start of a new build process or other significant development milestones. The timer's can be utilized to ensure that the dependency checks are conducted at the most opportune moments. For example, when the codebase is stable, just prior to new development work, or post-commit to the repository. This anticipatory timing can be effectively utilized for the proactive management of dependencies by detecting issues before they can have a downstream impact on the development process or production environment.

Block 402 involves the system scanning the software project's repository to locate files that list project dependencies, which can be integral to the project's build and runtime environments. Files such as package.json for Node.js projects, pom.xml for Maven projects, or requirements.txt for Python projects are some illustrative examples. The system can parse these files to create or update a comprehensive list of dependencies, noting the exact versions in use and other pertinent metadata, such as licenses or source URLs. The exhaustive identification of these files ensures that the present invention does not overlook any dependency, and thus provides complete and comprehensive health assessments and identifies any potential vulnerabilities in the project. In block 404, the system can dynamically generate or refresh an exhaustive catalog of all dependencies declared within the project's repository. This cataloging function systematically parses designated dependency descriptor files, such as package.json for JavaScript, pom.xml for Java projects, or other manifest files pertinent to the project's programming language and framework. In block 404, details for each listed dependency can be precisely extracted, documenting not only the version in use but also other metadata such as the source repository, licensing information, and any known issues tracked through integrated vulnerability databases. It can process this information to construct a comprehensive and up-to-date list that can serve as a foundation for subsequent operations in the dependency management workflow. This component is attuned to changes within the repository, employing event-driven triggers or polling mechanisms to detect updates to dependency files, ensuring the list reflects the latest project state. By maintaining an updated list, the system facilitates accurate health assessments and ensures that developers have access to current information for decision-making processes regarding dependency maintenance, updates, or replacements.

Block 406 determines whether the health of all dependencies, as listed from Block 404, has been recently assessed or updated. This can include a systematic check against a database of known vulnerabilities and other sources, such as advisories from the National Vulnerability Database (NVD), vendor security bulletins, or proprietary vulnerability databases. If the health status is current, the process progresses to block 408, suggesting new dependencies if required. If not, the process proceeds to block 412 to update the health status of these dependencies, indicating that there are dependencies requiring further analysis due to outdated health information. When the health of all dependencies is confirmed to be updated in block 406, a recommendation engine can be activated in block 408. This engine can leverage the latest health information to propose replacement, alternative dependencies for those that are identified as high-risk or problematic. The recommendation engine can incorporate a variety of data sources, including, for example, historical trends, security patch frequencies, and the adoption rates within the development community, to suggest replacements. It can also consider the compatibility and integration requirements of the existing technology stack, ensuring the recommended alternatives are technically and operationally viable for the project.

In various embodiments, in block 410, the system can be placed into a ‘sleep’ state after either confirming the updated health of all dependencies or suggesting new ones. This sleep state can conserve computational resources and prepare the system for the next interval set by the timer. During this period, the system can remain on standby, ready to reactivate and repeat the dependency health check cycle according to the schedule dictated by block 402. In the event that block 406 finds outdated health information, block 412 can initiate a targeted retrieval process for each dependency requiring an update. This can include accessing and compiling the latest data available for these dependencies from various trusted sources. These data points can encompass details such as, for example, the last date of maintenance, known security vulnerabilities, version history, and the frequency of updates.

In block 414, a detailed evaluation of each dependency flagged in block 412 can be performed by querying databases from services such as SYNK or employing scorecard metrics. This query analysis can include calculating a health score based on several factors, including known vulnerabilities, maintenance history, community engagement, and recency of updates. The comprehensive nature of this assessment ensures that the health score is a reliable indicator of the risk each dependency may pose to the project. Block 416 presents a conditional branch based on the health assessment results from block 414. Should the health score of a dependency fall below a predetermined threshold, it suggests a potentially low health status, prompting a ‘Yes’ branch to block 418 for seeking replacement, alternative dependencies. If the health score is above the threshold, implying satisfactory health, the flow loops back to block 406, signifying that the dependencies are in good standing and no further immediate action is required.

In various embodiments, upon a ‘Yes’ determination in block 416, block 418 can utilize web scraping techniques on developer platforms (e.g., GitHub) to source potential replacement, alternative dependencies. This can include sophisticated data mining of commit histories, issues, pull requests (PRs), and community discussions to discern trends and patterns where similar dependencies have been replaced, identifying credible alternatives that are being adopted by the broader development community. In block 420, a thorough evaluation of the health of these potential replacements can be conducted to ensure that the new dependencies not only resolve the immediate security or maintenance concerns but also are vetted for long-term viability and sustainability within the project's ecosystem. This vetting process can include reassessing the dependencies through the same stringent criteria used in block 414, ensuring consistency and reliability in the health assessment methodology.

In block 422, the evaluated replacements from block 420 can be processed by the system to establish a ranking based on combined factors of health and popularity. This ranking algorithm can include weighting factors such as, for example, the criticality of security patches, frequency of maintenance releases, extent of community adoption, and compatibility with the project's existing dependencies. This ranking process can incorporate a multi-factor algorithm that considers the frequency of updates, community support, security posture, and other relevant metrics to prioritize the optimal alternatives for recommendation and automatic implementation. In block 424, a central list of dependencies can be updated to include the new information gleaned from blocks 414 to 422. This update can furnish the project with the latest insights into dependency health and outlines recommended alternatives, complete with their respective rankings, facilitating informed decision-making about which dependencies to maintain, upgrade, or replace. This can provide an enriched dataset that reflects the current health status of each dependency and prescribes actionable insights into which dependencies should be replaced, with which alternatives, and in what order of priority, in accordance with aspects of the present invention.

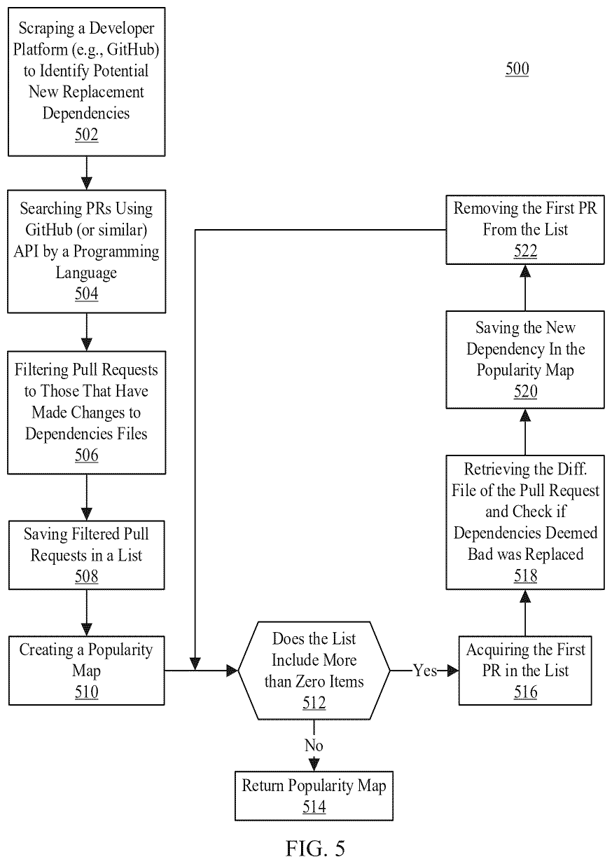

Referring now to FIG. 5, a method 500 for scraping developer platforms to identify new replacement dependencies for a software project, including searching and filtering pull requests to create a popularity map of potential alternatives, is illustratively depicted in accordance with embodiments of the present invention.

In various embodiments, in block 502, an automated script can be executed to scrape developer platforms like GitHub. This is a targeted operation where the system can employ advanced data extraction techniques to gather detailed information about community-driven changes to dependencies. The scraping mechanism can filter through repositories, focusing on instances where dependencies were replaced in response to issues such as security vulnerabilities or obsolescence. The script can intelligently categorize and collect data on what new dependencies were chosen as replacements and can record the frequency and context of these changes, capturing a broad yet detailed landscape of community trends and preferences in dependency management.

In block 504, a refined search through pull requests (PRs) (e.g., on GitHub) can be performed, utilizing the platform's API with a specific filter set for the project's programming language. The system can utilize a methodical approach, issuing API calls that retrieve PR data relevant to the software project's technology stack. It can evaluate programming language-specific changes, acknowledging that dependency management practices can vary significantly between languages. This can differentiate between general PRs and those determined to be pertinent to dependency changes, thereby focusing on the most actionable and relevant data for analysis. In block 506, the system can apply a specialized filter to the pull requests to isolate those that specifically modified dependency files. This filter can analyze the contents of each PR, discerning changes made to files like, for example, package.json, pom.xml, or Gemfile which can be indicative of dependency modifications. This filtering step can streamline the subsequent analysis by concentrating on pull requests that directly impact the project's dependencies, thus providing a high-fidelity signal for identifying replacement patterns.

In block 508, the filtered pull requests can be categorized into a structured list by the system, and each qualifying PR can be saved in, for example, a database or in-memory structure that facilitates easy retrieval and manipulation in later stages. The list can function as a curated repository of changes that have passed the initial relevance checks, setting the stage for in-depth analysis of community-driven dependency updates and migrations. In block 510, a popularity map can be constructed from the curated list of pull requests. This map is not a simple tally but rather can be a sophisticated model that can use various data points, including the frequency of a replacement's occurrence, the notoriety of the repositories where replacements were made, and the credibility of the contributors who made the changes. The popularity map can provide an aggregated, weighted view of community adoption for different dependency replacements, with nuances that reflect the multi-dimensional nature of ‘popularity’ in open-source ecosystems.

Block 512 introduces a decision checkpoint in the system's workflow. The process can assess whether the list of curated pull requests still contains items that have yet to be analyzed. This step can ensure that the system's operations progress logically by analyzing each PR in sequence and iterating through the list until all relevant data has been incorporated into the popularity map. After completing the analysis loop (e.g., if the list in Block 512 does not contain more items), in block 514, the system can finalize the popularity map and prepare it for output. This map can include a comprehensive aggregation of data reflecting the community's preferences and trends in dependency management, offering a nuanced perspective on the ecosystem of package replacements. The map can be processed through a visualization or compilation module that can transform and format the data into an easily interpretable format, suitable for presentation to end users. It can then be returned as a final output of the process, ready to be integrated into decision-making workflows, automated dependency adjustments, or further stages of, for example, a CI/CD pipeline for a software development life cycle (SDLC). In various embodiments, the returned popularity map can be utilized as a strategic tool to inform developers and system maintainers about the most viable and community-endorsed alternatives to problematic dependencies.

In various embodiments, in block 516, a foremost (e.g., highest ranked) pull request in the curated list can be selected for in-depth examination. This step can include programmatically highlighting the first PR to retrieve its diff file for analysis. This prioritization can facilitate a systematic and orderly processing of the data, ensuring that each PR is given due consideration. In block 518, the diff file of the current pull request can be retrieved by the system to examine the specific changes made. This can include parsing the diff file to identify if the previously marked ‘bad’ dependencies were indeed replaced. The diff file can represent a direct snapshot of changes between two versions, offering clear visibility into which dependencies were removed, which were added, and what, if any, versions were updated. In block 520, the popularity map can be updated with the new dependencies identified from the diff files. This can be an aggregation step where each validated replacement contributes to the overall map, affecting the popularity score of each alternative dependency. The system can iteratively record the frequency and context of each replacement to provide nuanced insight into community-driven decisions.

In block 522, after processing a pull request to extract and analyze changes to dependency files, the system can methodically remove this PR from the analysis queue. This is a housekeeping step to ensure that the same PR is not re-evaluated in subsequent cycles, maintaining the efficiency and integrity of the analysis process. The removal can be performed by the system's queue management component, which can track and update the list of pull requests awaiting examination in real-time. Once a PR is removed, its corresponding data, such as the identified new dependency information, can be securely archived for auditability and traceability purposes. This ensures that each pull request is given due consideration and the process flow can continue unimpeded, focusing on new data entries for optimal resource utilization and process continuity. The method 500 can include an automated, data-driven approach to identifying, proposing, and/or automatically implementing alternatives to problematic dependencies in software development, based on real-world data and community practices. It demonstrates a novel integration of technology that goes beyond basic vulnerability scanning, providing actionable insights and facilitating a proactive stance in maintaining the health and security of a software project's dependency tree, in accordance with aspects of the present invention.

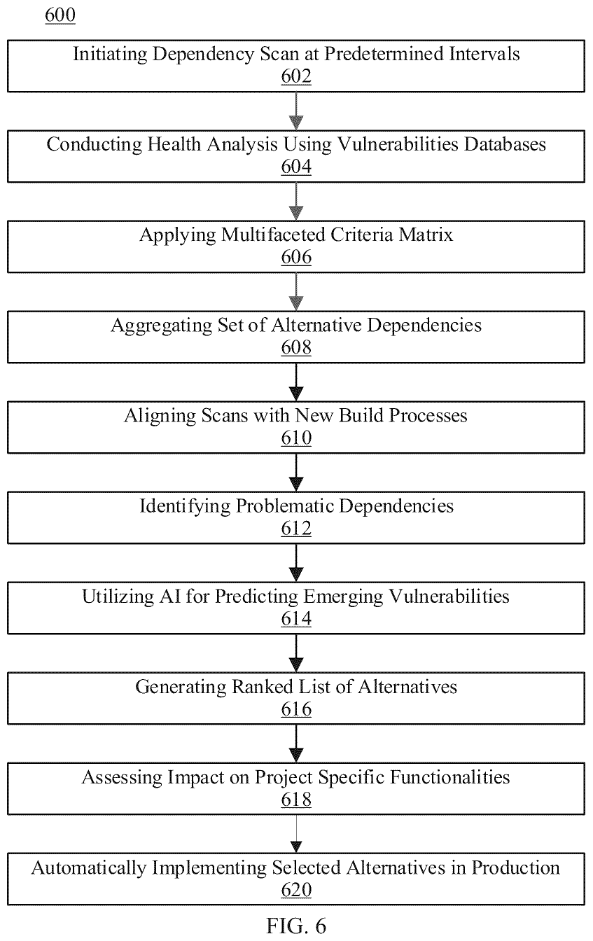

Referring now to FIG. 6, a method 600 for proactive dependency management system integrated within a CI/CD pipeline, including a dependency scan initiation and automated implementation of selected dependency alternatives in a production environment, is illustratively depicted in accordance with embodiments of the present invention.

In various embodiments, in block 602, a computer-implemented process can be activated to begin scanning within a version-controlled repository for the purpose of identifying and listing software project dependencies. This scan can be triggered at predetermined intervals that have been strategically selected to align with significant stages in the software development cycle rather than being triggered arbitrarily or at random, in accordance with aspects of the present invention. The initiation can be configured to, for example, coincide with events such as the commencement of each new build in a CI/CD pipeline or other events in the SDLC. This ensures that the dependency check can be conducted when the software is in a stable state, and any changes can be accounted for in the dependency list. Block 604 involves a thorough health analysis of the dependencies identified in block 602. The system, through this block, can access and assess multiple vulnerabilities databases to gather data on current security risks associated with the dependencies. The analysis can delve into the frequency and recency of maintenance updates, providing an assessment of each dependency's security posture. The data harvested from these databases can be utilized to pinpoint vulnerabilities and maintenance neglect, which can potentially compromise the software's integrity.

In block 606, a multifaceted criteria matrix can be applied to the results of the health analysis from block 604. This matrix can be a composite framework that evaluates dependencies against a range of risk indicators. These indicators can include but are not limited to, known security vulnerabilities and observable patterns of neglect such as lapses in routine updates and maintenance. By applying this matrix, the system can isolate dependencies that pose potential risks, thus prioritizing them for further action. In block 608, an aggregation of a set of alternative dependencies for those identified as at-risk in block 606 can be generated. The system can leverage analysis of public repositories to uncover commonly adopted replacements that other projects have successfully transitioned to. Additionally, it can evaluate the compatibility of these alternatives with the project's technology stack and their adherence to predetermined security and maintenance standards to ensure that any suggested replacements are not only less risky but also are an optimal fit for the specific needs of a particular software project of interest.

In block 610, the system can sure that the timing of dependency scans initiated in block 602 is in direct alignment with the initiation of new build processes within the CI/CD pipeline. This synchronization can be utilized for capturing the most current state of the project's dependencies, identifying new builds which can introduce changes to the dependency structure. Block 612 focuses on the criteria used to deem a dependency problematic, as established in block 606. A dependency can be flagged as problematic within this system if it is found to have known vulnerabilities or has not been maintained within a certain threshold period. These criteria can be based on the standards set within the software development project or user-set criteria, taking into account the criticality of the dependencies and the potential impact of their failure. In block 614, an artificial intelligence (AI) model can be trained, retrained, and/or utilized to predict emerging vulnerabilities that the dependencies may be subject to. This model can mine patterns from external vulnerability databases to forecast potential security risks. By anticipating these vulnerabilities, the system can proactively suggest preventive measures or replacements before the vulnerabilities are exploited.

Block 616 involves generating a ranked list of alternative dependencies. This ranking can be based on a comparison of various attributes such as, for example, a frequency of maintenance updates and a level of community endorsement each alternative has received. A weighted algorithm can be employed in this block to calculate the rankings, taking into account the security posture and the maintenance frequency to ensure that the most reliable and secure alternatives are given precedence. In block 618, the health analysis can include an additional layer of assessment where the system can consider an impact of potential vulnerabilities on specific functionalities utilized by the software development project. This assessment can ensure that any dependencies that are deemed critical to the project's key operations are given extra scrutiny, and their replacement does not disrupt these essential functionalities.

In various embodiments, in block 620, the selected alternative dependencies can be automatically implemented within a production environment. This step can be executed after a rigorous validation process that ensures the compatibility, security, and operational integrity of each alternative within the codebase. By automating the implementation process, the transition to safer dependencies can be streamlined and downtime or manual intervention can be minimized. A comprehensive validation sequence can be performed to ensure that the newly suggested dependencies are not only more secure and healthier but also fully compatible with the existing technological framework of the software project.

In various embodiments, the automatic implementation in block 620 can include an orchestrated series of actions which may involve several subsystems and components of the deployment infrastructure. For example, replacements for dependencies flagged as at-risk can be proposed by the system, and a detailed report explaining why each replacement was chosen can be generated based on the analysis in the previous blocks, in particular the rankings from block 616. Before deployment, the proposed dependencies can undergo a suite of automated tests and validations. These can ensure that the replacements do not introduce breaking changes or incompatibilities. Unit tests, integration tests, and system-level tests can be performed in an isolated staging environment that mirrors the production setup. Concurrent with testing, security checks can be conducted to scan for any residual or new vulnerabilities that can come with the alternative dependencies. Compliance checks can also be done to ensure that the new dependencies adhere to the regulatory and licensing requirements of the project.

Upon successful validation, the system can automatically modify the project's dependency configuration files (e.g., updating package.json in Node.js projects) with the new, healthier dependencies. This step can involve version control operations, such as committing changes to a repository, which are then subjected to a code review process, if desired or required by the development workflow. Block 620 can also include deploying the updated configuration into a production environment, which can include using infrastructure as code tools or orchestration systems that manage containerized applications. This deployment can be managed through, for example, a CI/CD pipeline, which can automatically trigger the deployment once the updated codebase passes all the checks and receives the necessary approvals.

Post-deployment, the system can closely monitor the application's performance and stability to detect any unforeseen issues arising from the new dependencies. If any critical problems are identified, automatic rollback mechanisms can revert the changes to the last known good state, ensuring minimal impact on production systems. Block 620 represents a phase in the dependency management lifecycle in which automation can bridge the gap between the identification of healthier dependencies and the realization of those benefits in a live production environment. By automating the implementation process, the system can substantially reduce the lead time for changes, minimizes human error, and ensures that the software project remains secure, stable, and up to date with the best possible set of dependencies, in accordance with aspects of the present invention.

Referring now to FIG. 7, a high-level view of a system 700 for real-time dependency health management by dependency identification, health analysis, risk assessment, and application of neural network algorithms for predictive analysis and decision-making support in software development projects, is illustratively depicted in accordance with embodiments of the present invention.

In various embodiments, a dependency identification device 702 can be programmed to scan a version-controlled repository to identify and list all project dependencies. This can be triggered at predetermined intervals, including, for example, in synchronization with the CI/CD pipeline process, ensuring a consistent and updated view of the project's dependencies. This can be part of an automated routine, aligned with, for example, nightly builds or other scheduled maintenance tasks, and is designed to locate dependency declaration files such as package.json for Node.js applications or equivalent. A health analysis engine 704 represents the component tasked with conducting an extensive health analysis of the dependencies listed by the dependency identification device 702. This engine can be integrated with several vulnerability databases and can utilize data to uncover current security vulnerabilities and maintenance histories. The analysis can include not only scanning for known issues but also assessing the frequency of updates and other maintenance indicators, applying sophisticated algorithms and heuristic evaluations, in accordance with aspects of the present invention.

The system 700 can analyze, by a risk assessment processor 706, the data collected by the health analysis engine 704 using a multifaceted criteria matrix. This risk assessment processor 706 can isolate dependencies that present indicators of potential risk such as, for example, known security vulnerabilities or patterns indicative of neglect in maintenance. By leveraging this matrix, the risk assessment processor 706 can categorize dependencies into risk levels, facilitating the prioritization of remediation efforts. An alternative dependency aggregator 708 can be utilized to aggregate and propose alternative dependencies for those identified as high-risk. This component can utilize public repository analysis, such as data from GitHub's public API, to find commonly adopted replacements, and can assess these alternatives for compatibility with the project's technology stack as well as compliance with security and maintenance standards. The system 700 can include a user interaction interface 710, which can be a graphical user interface (GUI) or other user interaction system that allows for real-time interaction, display, and query functionalities. It provides an interface for users, such as developers or system administrators, to review suggested dependency changes, approve replacements, and configure or adjust the system's operational parameters.

In various embodiments, an AI-powered vulnerability prediction device 712 can be responsible for utilizing an artificial intelligence model to predict future vulnerabilities in dependencies based on historical patterns identified from various vulnerability databases. This can include utilizing machine learning algorithms to analyze past data and project potential security risks, aiding developers in preemptively addressing issues before they manifest in the codebase. A dependency ranking device 714 can be utilized to evaluate and rank alternative dependencies sourced from public repositories. This can include using a weighted algorithm to prioritize alternatives based on criteria such as the frequency of maintenance updates, community endorsements, and security posture. The outputs from this system can further provide developers with a ranked list of alternative dependencies to facilitate informed decision-making.

A proactive dependency update scheduler 716 can schedule regular (e.g., hourly, daily, weekly, daytime, nighttime, etc.) scans and analyses of the project's dependencies to ensure that dependency checks and updates are carried out at predetermined intervals which can be aligned with the CI/CD pipeline to maintain the ongoing health and security of the software project. A Neural Network/Neural Network Trainer 718 for dependency evaluation can evaluate and enhance the health assessment of software dependencies using neural network algorithms. Block 718 can include a training component that consumes vast amounts of data from project dependencies, their maintenance histories, security vulnerability reports, and community activity to learn and identify complex patterns and correlations that may not be apparent through traditional analysis methods. The neural network can be trained to recognize patterns in the dependency data that could indicate emerging vulnerabilities or signs of obsolescence and neglect. For example, it can learn to predict which dependencies are likely to become problematic based on the maintenance behavior observed in related projects or according to the update patterns of similar dependencies. By continuously learning from new data, the neural network can iteratively refine the criteria for dependency health scoring, and can dynamically adjust the health scores based on real-time data, providing a more accurate reflection of each dependency's current state.

In various embodiments, the neural network can contribute to the risk assessment processor 706, offering nuanced insights that can fine-tune the multifaceted criteria matrix applied to analyze dependencies. It can enable the system to adapt the risk thresholds for dependencies based on evolving trends and insights derived from its continuous learning process. In collaboration with the dependency ranking device 714, the neural network can utilize its predictive capabilities to not only rank existing alternatives but also to suggest future-proof replacements that are less likely to encounter security issues or become deprecated. Post-implementation, the neural network can receive feedback on the success and stability of the replaced dependencies, which it can use to further train its models. This feedback loop can ensure that the network's future recommendations are grounded in the empirical results of past replacements.

The user interaction interface 710 can be utilized by users (e.g., developers) to provide input on the network's recommendations, which can include approvals, rejections, or modifications. This human-in-the-loop approach can be utilized to ensure that the neural network's learning is aligned with developer expertise and project-specific nuances. By integrating a neural network/neural network trainer 718 into the system, the present invention can utilize advanced AI techniques to significantly enhance the accuracy and effectiveness of proactive dependency management. It ensures that the system not only responds to the current landscape of software dependencies but also anticipates future challenges, thereby maintaining the integrity and security of the software development project over time.

A dependency implementor device 720 can coordinate the automated replacement of problematic dependencies with selected alternatives. This can manage the execution of necessary steps to update the project's dependencies, including modification of dependency configuration files, committing changes to version control, and orchestrating the build and deployment processes. Block 722 represents a continuous monitoring and alerting device, which can constantly monitor the project's dependencies for new vulnerabilities and maintenance issues in real-time. It can alert developers to newly discovered risks in real-time and can provide updated recommendations for alternative dependencies as they become available. An integration and compatibility testing suite 724 can include a series of automated testing frameworks designed to validate the compatibility and functional integrity of each proposed alternative dependency within the current codebase. This suite can conduct a variety of tests to ensure that new dependencies integrate seamlessly and maintain the operational stability of the software project, in accordance with aspects of the present invention.

Referring now to FIG. 8, a system 800 for improved, real-time software dependency health management by dependency identification, health analysis, risk assessment, and application of neural network algorithms for predictive analysis and decision-making support in software development projects, is illustratively depicted in accordance with embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as code for improved software dependency identification and dependency replacement 850. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 200, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated. PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.”

In some computing environments, processor set 810 may be designed for working with qubits and performing quantum computing. Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths. VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801. PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices.

Operating system 822 may take several forms, such as various known proprietary operating systems or open source Portable Operating System Interface-type operating systems that employ a kernel. The code included in block 200 typically includes at least some of the computer code involved in performing the inventive methods. PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits.

In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices.

Computer readable program instructions for performing the inventive methods can typically be downloaded to computer 801 from an external computer or external storage device through a network adapter card or network interface included in network module 815. WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844.

It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for proactive dependency management in software development projects, comprising:
initiating a dependency scan within a version-controlled repository to identify and list project dependencies at predetermined intervals;
conducting a health analysis for the project dependencies listed by accessing and utilizing data from a plurality of vulnerabilities databases, the analysis uncovering current security vulnerabilities and assessing a frequency and recency of maintenance updates;
applying a multifaceted criteria matrix to analyzed dependencies to isolate those that exhibit indicators of potential risk, including known security vulnerabilities and evidence of neglect of updates and maintenance; and
aggregating a set of alternative dependencies for identified at-risk dependencies by leveraging public repository analysis to discern commonly adopted replacements, further evaluating the alternative dependencies for compatibility with a technology stack of the software development projects and adherence to security and maintenance standards.

2. The method of claim 1, wherein the predetermined intervals are aligned with the initiation of each new build process within a continuous integration/continuous deployment (CI/CD) pipeline.

3. The method of claim 1, wherein a dependency is deemed problematic if it meets criteria including a presence of known vulnerabilities or lack of maintenance during a threshold time period.

4. The method of claim 1, further comprising utilizing an artificial intelligence model to predict emerging vulnerabilities based on patterns found in external vulnerabilities databases.

5. The method of claim 1, further comprising generating a ranked list of alternative dependencies by prioritizing alternative dependencies based on a comparison of a frequency of maintenance updates and community endorsements within a predetermined time period, and ranking the alternative dependencies based on a weighted algorithm that considers security posture and a frequency of maintenance.

6. The method of claim 1, wherein the health analysis further includes assessing an impact of potential vulnerabilities on specific functionalities utilized by the software development project.

7. The method of claim 1, further comprising automatically implementing selected alternative dependencies in a production environment after validating compatibility, security, and operational integrity of implementing each of the alternative dependencies within a codebase for the software development projects.

8. A system for proactive dependency management in software development projects, comprising:
a processor device; and
a memory storing instructions that, when executed by the processor device, cause the system to:
initiate a dependency scan within a version-controlled repository to identify and list project dependencies at predetermined intervals;
conduct a health analysis for the project dependencies listed by accessing and utilizing data from a plurality of vulnerabilities databases, the analysis uncovering current security vulnerabilities and assessing a frequency and recency of maintenance updates;
apply a multifaceted criteria matrix to analyzed dependencies to isolate those that exhibit indicators of potential risk, including known security vulnerabilities and evidence of neglect of updates and maintenance; and
aggregate a set of alternative dependencies for identified at-risk dependencies by leveraging public repository analysis to discern commonly adopted replacements, further evaluating the alternative dependencies for compatibility with a technology stack of the software development projects and adherence to security and maintenance standards.

9. The system of claim 8, wherein the predetermined intervals are aligned with the initiation of each new build process within a continuous integration/continuous deployment (CI/CD) pipeline.

10. The system of claim 8, wherein a dependency is deemed problematic if it meets criteria including a presence of known vulnerabilities or lack of maintenance during a threshold time period.

11. The system of claim 8, further comprising utilizing an artificial intelligence model to predict emerging vulnerabilities based on patterns found in external vulnerabilities databases.

12. The system of claim 8, further comprising generating a ranked list of alternative dependencies for each of the dependencies deemed problematic by mining data from multiple public repositories and evaluating a security profile and maintenance history for each of the alternative dependencies against a set of predetermined benchmarks, and ranking the alternative dependencies based on a weighted algorithm that considers security posture and a frequency of maintenance.

13. The system of claim 8, wherein the health analysis further includes assessing an impact of potential vulnerabilities on specific functionalities utilized by the software development projects.

14. The system of claim 8, further comprising automatically implementing selected alternative dependencies in a production environment after validating compatibility, security, and operational integrity of implementing each of the alternative dependencies within a codebase for the software development projects.

15. A computer program product for dynamic dependency management in software development projects, the computer program product comprising a computer readable storage medium having program instructions embodied therewith, the program instructions executable by a hardware processor to cause the hardware processor to:
initiate a dependency scan within a version-controlled repository to identify and list project dependencies at predetermined intervals;
conduct a health analysis for the project dependencies listed by accessing and utilizing data from a plurality of vulnerabilities databases, the analysis uncovering current security vulnerabilities and assessing a frequency and recency of maintenance updates;
apply a multifaceted criteria matrix to analyzed dependencies to isolate those that exhibit indicators of potential risk, including known security vulnerabilities and evidence of neglect of updates and maintenance; and
aggregate a set of alternative dependencies for identified at-risk dependencies by leveraging public repository analysis to discern commonly adopted replacements, further evaluating the alternative dependencies for compatibility with a technology stack of the software development projects and adherence to security and maintenance standards.

16. The computer program product of claim 15, wherein the predetermined intervals are aligned with the initiation of each new build process within a continuous integration/continuous deployment (CI/CD) pipeline.

17. The computer program product of claim 15, wherein a dependency is deemed problematic if it meets criteria including a presence of known vulnerabilities or lack of maintenance during a threshold time period.

18. The computer program product of claim 15, further comprising instructions for generating a ranked list of alternative dependencies for each of the dependencies deemed problematic by mining data from multiple public repositories and evaluating a security profile and maintenance history for each of the alternative dependencies against a set of predetermined benchmarks, and ranking the alternative dependencies based on a weighted algorithm that considers security posture and a frequency of maintenance.

19. The computer program product of claim 15, further comprising instructions for integration into a continuous integration/continuous deployment (CI/CD) pipeline for automated dependency management for software deployment workflows.

20. The computer program product of claim 15, further comprising instructions for automatically implementing selected alternative dependencies in a production environment after validating compatibility, security, and operational integrity of implementing each of the alternative dependencies within a codebase for the software development projects.
